(19) United States
(12) Patent Application Publication
(10) Pub. No.: US 2011/0068994 A1
(43) Pub. Date: Mar. 24, 2011

(54) COMMUNICATION MODULE, COMMUNICATION APPARATUS

(75) Inventor: Yasuharu MATSUOKA, Osaka (JP)

(73) Assignee: PANASONIC CORPORATION, Osaka (JP)

(21) Appl. No.: 12/872,295

(22) Filed: Aug. 31, 2010

(30) Foreign Application Priority Data
Sep. 18, 2009 (JP) JP2009-217654

(51) Int. Cl. H01Q 1/52

(52) U.S. Cl. 343/841

(57) ABSTRACT

A communication module of the present application includes a first antenna element 12, a second antenna element 13, and a ground portion 14. The first antenna element 12 and the second antenna element 13 can transmit and receive radio signals. The ground portion 14 is provided between the first antenna element 12 and the second antenna element 13 and can suppress electrical interference between the first antenna element 12 and the second antenna element 13. The ground portion 14 is a ground potential. Thus, the unwanted radio waves leaking from the first antenna element 12 and the second antenna element 13 are grounded electrically, so that the degradation of isolation can be suppressed.

### BACKGROUND

1. Field

The present application relates to a communication module. The present application relates to a communication apparatus including the communication module.

2. Description of Related Art

In recent years, an information device such as a notebook computer provided with a wireless communication system is becoming mainstream. The wireless communication system is, e.g., a system that is connected to the network by wireless such as LAN (local area network) or a system that is connected to an access point by wireless such as Bluetooth (registered trademark). In particular, an information device that has a plurality of types of wireless communication systems and selectively can perform wireless communications has been developed. Examples of the wireless communication system incorporated into the information device include a wireless LAN, a wireless WAN (wide area network), and the Bluetooth. When these wireless communication systems are incorporated into a single information device, the transmission frequency band and the reception frequency band of radio generally differ depending on the type of wireless communication system. However, some wireless communication systems use the same frequency band. For example, both the wireless LAN in conformity with the IEEE 802.11 standard and the Bluetooth use the 2.4 GHz band.

In the case where the information device includes a plurality of antenna elements that transmit and receive radio waves in the same frequency band, isolation between the antenna elements is degraded if the antenna elements are located close to each other. Thus, the transmission and reception characteristics of each of the antenna elements may be degraded. To suppress the degradation of the isolation, the antenna elements can be spaced away from each other. However, this leads to an increase in size of the information device. As a technique of improving the isolation between the antenna elements without increasing the size of the information device, a configuration has been proposed in which a ground pattern is provided in the vicinity of the antenna elements.

JP 2004-328717 A discloses a diversity antenna with a layered structure in which a substrate having a plurality of flat antenna elements and a substrate having a hybrid pattern that switches the antenna elements are formed via a substrate having a ground pattern.

However, the ground pattern of JP 2004-328717 A is provided on the substrate that is interposed between the substrate having the hybrid pattern and the substrate having the antenna elements. Such a ground pattern is less effective in suppressing mutual interference between transmitting/receiving surfaces of the respective flat antenna elements disposed on the substrate. Consequently, an improvement in the isolation between the transmitting/receiving surfaces of the antenna elements cannot be expected much.

### SUMMARY

A communication module of the present application includes a plurality of antenna elements, each of which has a transmitting/receiving surface that transmits and receives radio signals, and an isolation member that is provided between the plurality of antenna elements and has a ground potential to suppress electrical interference between the transmitting/receiving surfaces of the respective antenna elements.

A communication apparatus of the present application includes a communication module. The communication module includes a plurality of antenna elements, each of which has a transmitting/receiving surface that transmits and receives radio signals, and an isolation member that is provided between the plurality of antenna elements and has a ground potential to suppress electrical interference between the transmitting/receiving surfaces of the respective antenna elements.

### BRIEF DESCRIPTION OF THE DRAWINGS

FIG. 1 is a perspective view of a notebook computer that is an example of a communication apparatus according to an embodiment.

FIG. 2 is a plan view of a first case of the notebook computer.

FIG. 3A is a plan view of a communication module according to an embodiment.

FIG. 3B is a cross-sectional view taken along the line Z-Z in FIG. 3A.

FIG. 4A is a plan view showing the main portion of a communication apparatus incorporating a communication module according to an embodiment.

FIG. 4B is a cross-sectional view taken along the line Z-Z in FIG. 4A.

FIG. 5A is a plan view showing a modified example of a communication module.

FIG. 5B is a cross-sectional view taken along the line Z-Z in FIG. 5A.

FIG. 6A is a plan view showing a modified example of a communication module.

FIG. 6B is a cross-sectional view taken along the line Z-Z in FIG. 6A.

### DETAILED DESCRIPTION OF THE EMBODIMENTS

The communication module or the communication apparatus of this embodiment includes a plurality of antenna elements, each of which has a flat transmitting/receiving surface that transmits and receives radio signals, and an isolation member that has a flat surface, is provided between the transmitting/receiving surfaces of the plurality of antenna elements, and has a ground potential to suppress electrical interference between the plurality of antenna elements.

In the communication module or the communication apparatus of this embodiment, the plurality of antenna elements may be configured so that frequency bands of the radio signals transmitted and received by the antenna elements are the same. With this configuration, even if the isolation between the antenna elements that can transmit and receive radio waves in the same frequency band is degraded relatively significantly, the degradation of the isolation can be suppressed.

The communication module or the communication apparatus of this embodiment further may include a substrate on which the plurality of antenna elements and the isolation member are mounted. The plurality of antenna elements and the isolation member may be located on the same face of the substrate. This configuration can suppress the degradation of the isolation between the antenna elements. Moreover, since the number of substrates is reduced, this configuration also can reduce the cost and the man-hours required to incorporate the substrates into the communication apparatus. Furthermore, the communication module and the communication apparatus can have a small size.

The communication module or the communication apparatus of this embodiment further may include a substrate on which the plurality of antenna elements and the isolation member are mounted. The isolation member may be located in at least one location selected from a first surface of the substrate on which the plurality of antenna elements are mounted, a second surface of the substrate that is on the opposite side of the first surface, and a region between the first surface and the second surface of the substrate. This configuration can increase the area of the ground pattern without increasing the size of the communication module. Since the area of the ground pattern can be increased, the effect of suppressing the degradation of the isolation can be improved further.

### Embodiment 1

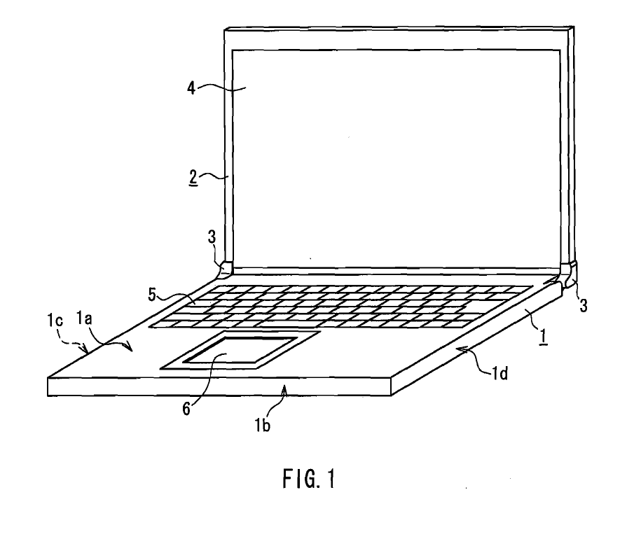

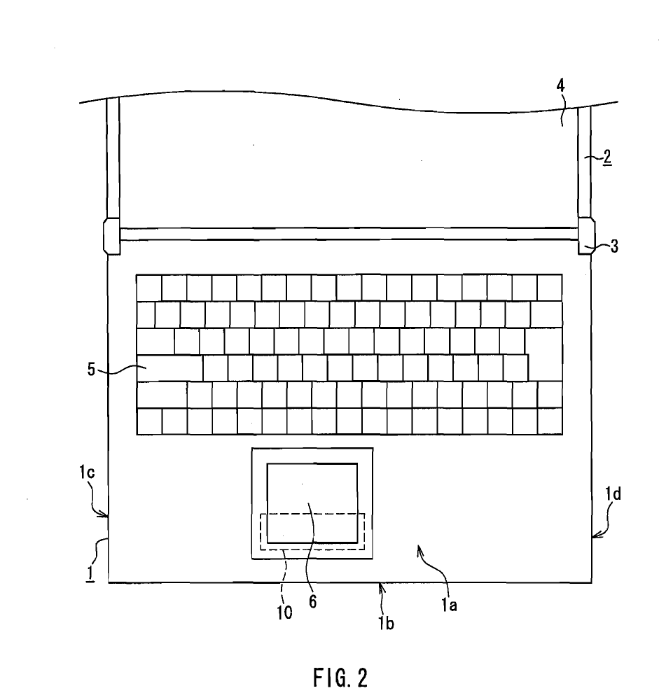

FIG. 1 is a perspective view showing the appearance of a communication apparatus of this embodiment. FIG. 1 illustrates a notebook computer as an example of the communication apparatus. FIG. 2 is a plan view of a first case of the notebook computer of this embodiment. This embodiment describes the notebook computer having a wireless communication system as an example of the communication apparatus. However, any apparatuses such as a portable telephone, an electronic game machine, and medical equipment may be used as long as they have at least a plurality of radio communication systems.

As shown in FIG. 1, the notebook computer includes a first case 1 and a second case 2. The first case 1 contains a circuit board on which various electric elements are mounted, a hard disk drive, etc. The second case 2 is provided with a liquid crystal display 4. The first case 1 and the second case 2 are supported rotatably by hinges 3. The hinges 3 have a rotation axis for supporting the first and second cases 1, 2 rotatably. A keyboard 5 and a pointing device 6 are provided on an upper surface 1a of the first case 1. The keyboard 5 allows a user to input various characters. The pointing device 6 is fixed in the first case 1 with its operating surface being exposed on the surface of the first case 1. The pointing device 6 allows a user to touch the operating surface and move the cursor displayed on a liquid crystal display 2a to a desired position.

As shown in FIG. 2, the notebook computer of this embodiment includes a communication module 10 that can perform wireless communications. The communication module 10 is contained in the first case 1. The communication module 10 is located so as to overlap with the pointing device 6 in the thickness direction of the first case 1.

Although FIG. 2 shows an example of the placement of the communication module 10, in terms of suppressing an increase in size of the notebook computer and ensuring the transmission and reception characteristics, the communication module 10 is located preferably at the position that overlaps with the pointing device 6. Since relatively large members such as an electric circuit board (e.g., motherboard), a hard disk drive, and a battery are contained in the first case 1, and recent notebook computers are increasingly smaller and thinner, it becomes more and more difficult to provide a space for the communication module 10 inside the first case 1. Furthermore, to ensure good transmission and reception characteristics of the communication module 10, it is preferable that the communication module 10 is located as close as possible to the side 1b, 1c, or 1d of the first case 1. However, in many cases, a PC card slot and input/output terminals are placed on the sides 1c, 1d. Therefore, a space for the communication module 10 is not likely to be available. Thus, in this embodiment, the communication module 10 is placed in a space under the pointing device 6, so that the size of the first case 1 is not increased, and the transmission and reception characteristics are ensured because the communication module 10 is close to the side 1b.

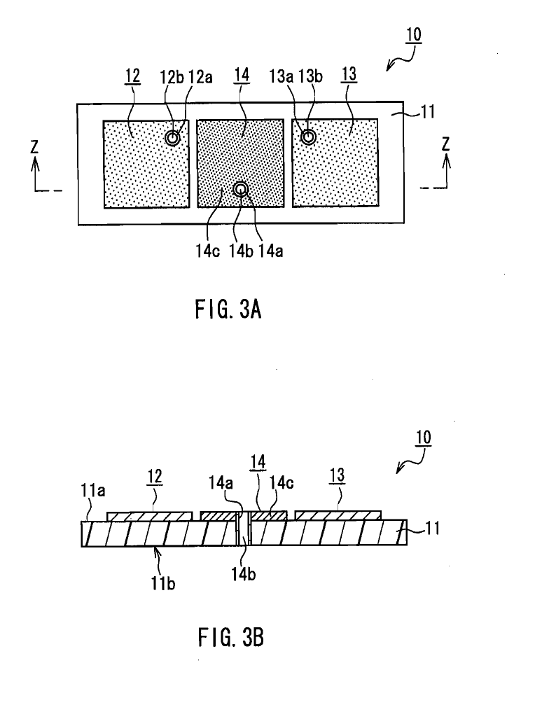

FIG. 3A is a plan view of the communication module 10. FIG. 3B is a cross-sectional view taken along the line Z-Z in FIG. 3A. The communication module 10 includes a substrate 11, a first antenna element 12, a second antenna element 13, and a ground portion 14. The first antenna element 12, the second antenna element 13, and the ground portion 14 are disposed on a surface 11a of the substrate 11. The first antenna element 12, the second antenna element 13, and the ground portion 14 can be formed on the surface 11a of the substrate 11, e.g., by a patterning method.

The first antenna element 12 and the second antenna element 13 can transmit and receive radio waves in the same frequency band. Each of the first and second antenna elements 12, 13 has a flat transmitting/receiving surface that transmits and receives radio signals. In this embodiment, the first antenna element 12 can transmit and receive radio waves in conformity with the IEEE 802.11 standard (wireless LAN). The second antenna element 13 can transmit and receive radio waves in conformity with the Bluetooth standard. Both the IEEE 802.11 standard and the Bluetooth standard are communication standards using the 2.4 GHz band. Each of the first and second antenna elements 12, 13 includes an antenna, a receiving circuit, a transmitting circuit, etc. The first antenna element 12 has an internal pattern 12a and a hole 12b. The second antenna element 13 has an internal pattern 13a and a hole 13b. The internal pattern 12a is used to ground electrically the first antenna element 12. The internal pattern 13a is used to electrically ground the second antenna element 13. The holes 12b, 13b receive screws 15a, 15b (as will be described later) for fixing the communication module 10 to the notebook computer and pass through the first antenna element 12, the second antenna element 13, and the substrate 11. The internal patterns 12a, 13a are formed through the holes 12b, 13b to the back 11b of the substrate 11.

The ground portion 14 is a ground potential. The ground portion 14 has a flat surface and is provided between the first antenna element 12 and the second antenna element 13. The ground portion 14 includes an internal pattern 14a, a hole 14b, and a ground pattern 14c. The ground pattern 14c is disposed on the surface 11a of the substrate 11. The ground pattern 14c is formed of a conductor such as a metal, and preferably is formed of a material with excellent conductivity such as copper. The hole 14b receives a screw 15c (as will be described later) for fixing the communication module 10 to the notebook computer and passes through the ground pattern 14c and the substrate 11. The internal pattern 14a is formed on the inner wall of the hole 14b and connected electrically to the ground pattern 14c.

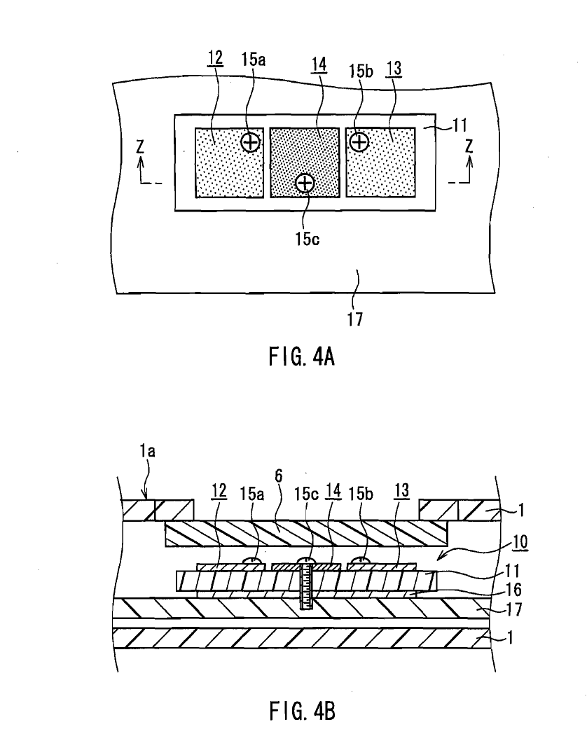

FIG. 4A is a plan view showing the main portion when the communication module 10 is incorporated into the notebook computer shown in FIG. 1. FIG. 4A illustrates the structure of the first case 1 in the vicinity of the pointing device 6 in the notebook computer, but omits the pointing device 6 for the sake of clarification. FIG. 4B is a cross-sectional view taken along the line Z-Z in FIG. 4A. FIG. 4B shows the first case 1, the pointing device 6, and the communication module 10 to clarify the positional relationship between them.

As shown in FIGS. 4A and 4B, the communication module 10 is fixed to a frame 17 in the first case 1 by the screws 15a to 15c. The frame 17 is provided with a metal plating layer 16. Thus, when the communication module 10 is fixed to the frame 17, the internal pattern 12a of the first antenna element 12, the internal pattern 13a of the second antenna element 13, and the internal pattern 14a of the ground portion 14 are in contact with the metal plating layer 16. In this manner, the first antenna element 12, the second antenna element 13, and the ground portion 14 can be grounded. In this embodiment, the metal plating layer 16 is provided because the frame 17 is made of an insulator such as a resin. However, if the frame 17 is made of a conductor such as a metal, the metal plating layer 16 can be removed. Moreover, if the frame 17 is a conductor, and the screws 15a to 15c are conductors such as metals, the internal patterns 12a, 13a, and 14a are not necessarily required.

When the communication module 10 shown in FIGS. 4A and 4B performs communications based on the wireless LAN standard, first, the first antenna element 12 is actuated. The first antenna element 12 can receive externally propagating radio waves with the receiving circuit via the inner antenna. The first antenna element 12 also can send a transmission signal that is generated by the transmitting circuit to the outside via the antenna. On the other hand, when the communication module 10 performs communications based on the Bluetooth standard, the second antenna element 13 is actuated. The second antenna element 13 can receive externally propagating radio waves with the receiving circuit via the inner antenna. The second antenna element 13 also can send a transmission signal that is generated by the transmitting circuit to the outside via the antenna.

In this case, since the first antenna element 12 and the second antenna element 13 are designed to transmit and receive radio waves in the same frequency band, the radio waves may leak from the first antenna element 12 to the second antenna element 13 or from the second antenna element 13 to the first antenna element 12. This embodiment provides the ground portion 14 between the first antenna element 12 and the second antenna element 13, and therefore can release the unwanted radio waves leaking from one of the first and second antenna elements 12, 13 to the other via the ground portion 14 and the metal plating layer 16. Thus, the degradation of the isolation between the first antenna element 12 and the second antenna element 13 can be suppressed.

In this embodiment, the ground portion 14 is provided between the first antenna element 12 and the second antenna element 13 of the communication module 10, thereby suppressing the degradation of the isolation between the first antenna element 12 and the second antenna element 13. Accordingly, the degradation of the transmission and reception characteristics of the communication module 10 can be suppressed.

The arrangement of the ground portion 14 between a plurality of antenna elements that transmit and receive radio waves in the same frequency band further can increase the effect of improving the isolation. If a plurality of antenna elements using radio waves in the same frequency band are located close to each other, the isolation between the antenna elements is likely to be degraded. However, such degradation of the isolation can be suppressed by providing the ground portion 14 between the first antenna element 12 and the second antenna element 13, as described in this embodiment.

The first antenna element 12, the second antenna element 13, and the ground portion 14 are placed together on the same substrate 11, and thus can share the wiring in the substrate, resulting in a small communication module. Moreover, the communication apparatus including this communication module can be made smaller. If the first antenna element 12, the second antenna element 13, and the ground portion 14 are mounted on separate substrates, man-hours are required to fix each of the substrates to the communication apparatus. However, the man-hours for fixing the individual substrates to the communication apparatus can be reduced by mounting the first antenna element 12, the second antenna element 13, and the ground portion 14 together on a single substrate.

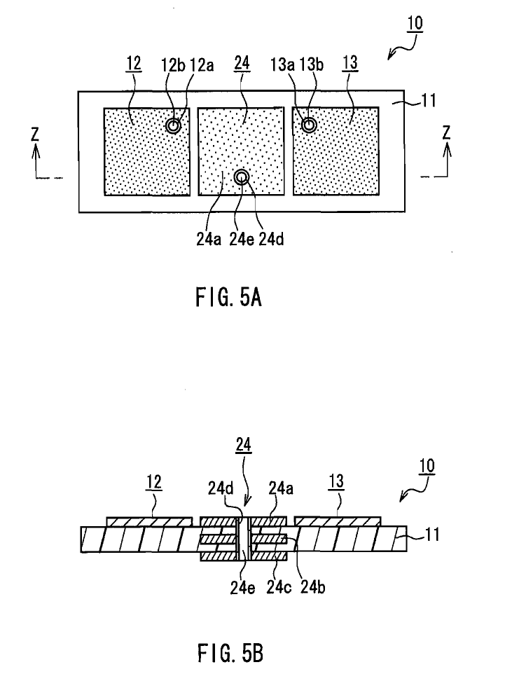

In the ground portion 14 of this embodiment, although the ground pattern 14c is disposed on the surface 11a of the substrate 11 as shown in FIG. 3B, another ground pattern may be disposed on the back 11b of the substrate 11. Moreover, a ground pattern may be disposed inside the substrate 11. FIG. 5A is a plan view showing a modified example of the communication module of this embodiment. FIG. 5B is a cross-sectional view taken along the line Z-Z in FIG. 5A. As shown in FIGS. 5A and 5B, a ground portion 24 includes a first pattern 24a disposed on the surface 11a of the substrate 11, a second pattern 24b disposed inside the substrate 11, and a third pattern 24c disposed on the back 11b of the substrate 11. The first pattern 24a, the second pattern 24b, and the third pattern 24c are arranged in layers in the thickness direction of the substrate 11. This configuration further can suppress the degradation of the isolation between the first antenna element 12 and the second antenna element 13. When the ground pattern (i.e., the second ground pattern 24b) further is disposed inside the substrate 11, no space is needed to dispose a ground pattern on the surface 11a and the back 11b of the substrate 11. Thus, the effect of suppressing the degradation of the isolation can be increased without increasing the size of the communication module 10. The ground pattern disposed inside the substrate 11 is not limited to a single layer as shown in FIG. 5B, and may be formed as a plurality of layers.

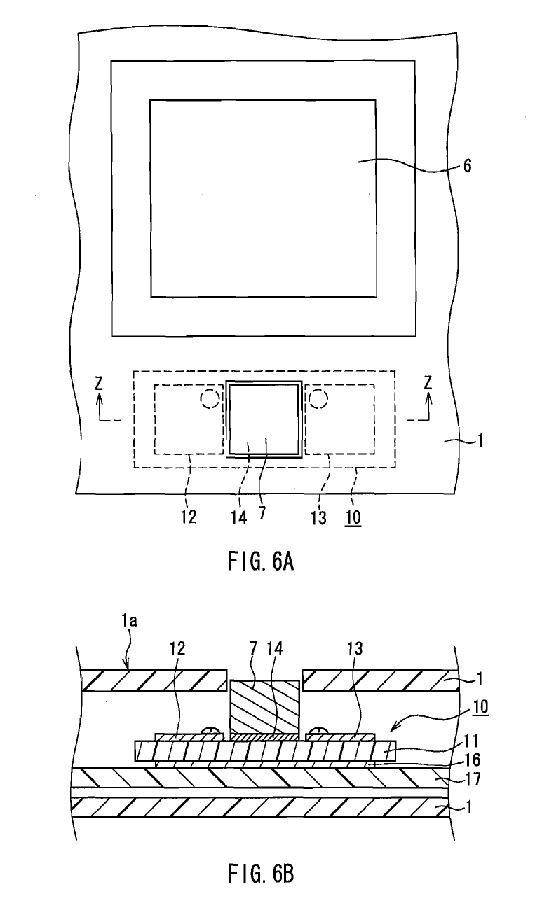

Another module may be provided on the ground portion 14. FIG. 6A is a plan view showing a modified example of the notebook computer of this embodiment and illustrates the main portion in the vicinity of the pointing device 6. FIG. 6B is a cross-sectional view taken along the line Z-Z in FIG. 6A. As shown in FIG. 6A, the notebook computer in this modified example has a fingerprint sensor 7 near the pointing device 6. The fingerprint sensor 7 detects the contact of a finger of the user's hand. The notebook computer compares the fingerprint of the user read by the fingerprint sensor 7 with previously registered fingerprints. If there is a match, then the user is allowed to operate the notebook computer. If there is no match, then the user is not allowed to operate the notebook computer. The fingerprint sensor 7 is bonded on the ground portion 14, as shown in FIG. 6B. In this case, a ground terminal (not shown) of the fingerprint sensor 7 is connected electrically to the ground portion 14, which eliminates the need for wiring or the like that connects the ground terminal (not shown) of the fingerprint sensor 7 to the ground pattern in the notebook computer. Thus, cost reduction and space saving can be achieved.

In the configuration of FIGS. 6A and 6B, although the fingerprint sensor 7 is provided on the ground portion 14, other elements also may be provided. Needless to say, it is preferable that the element provided on the ground portion 14 does not have an adverse effect on the isolation between the first antenna element 12 and the second antenna element 13.

The communication standard for each of the first and second antenna elements 12, 13 is an example. The first antenna element 12 and the second antenna element 13 may be adaptable to at least the communication standards using the same frequency band.

The communication module of this embodiment includes two antenna elements, but may include three or more antenna elements. In such a case, ground patterns may be provided between each of the antenna elements, so that the effect similar to that of this embodiment can be obtained.

The communication module of this embodiment may be applied not only to the equipment (a notebook computer, a game machine, etc.) that usually can be used alone, but also to, e.g., the peripheral equipment. For example, the communication module may be applied to a network device that can be connected externally to a notebook computer. The network device may be, e.g., a network card that includes a connector having a shape in conformity with the PCMCIA (personal computer memory card international association) standard or a network device that can be connected to an external connection terminal such as a USB (universal serial bus) terminal provided in a notebook computer. The above peripheral equipment is included in the scope of the communication apparatus of the present invention.

The first antenna element 12 and the second antenna element 13 of this embodiment are examples of the antenna elements of the present invention. The ground portions 14, 24 of this embodiment are examples of the isolation member of the present invention.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A communication module comprising:
a plurality of antenna elements, each of which has a transmitting/receiving surface that transmits and receives radio signals; and
an isolation member that is provided between the plurality of antenna elements and has a ground potential to suppress electrical interference between the transmitting/receiving surfaces of the respective antenna elements.

2. The communication module according to claim 1, wherein frequency bands of the radio signals transmitted and received by the plurality of antenna elements are the same.

3. The communication module according to claim 1, further comprising a substrate on which the plurality of antenna elements and the isolation member are mounted,
wherein the plurality of antenna elements and the isolation member are located on the same face of the substrate.

4. The communication module according to claim 2, further comprising a substrate on which the plurality of antenna elements and the isolation member are mounted,
wherein the plurality of antenna elements and the isolation member are located on the same face of the substrate.

5. The communication module according to claim 1, further comprising a substrate on which the plurality of antenna elements and the isolation member are mounted,
wherein the isolation member is located in at least one location selected from a first surface of the substrate on which the plurality of antenna elements are mounted, a second surface of the substrate that is on an opposite side of the first surface, and a region between the first surface and the second surface of the substrate.

6. The communication module according to claim 2, further comprising a substrate on which the plurality of antenna elements and the isolation member are mounted,
wherein the isolation member is located in at least one location selected from a first surface of the substrate on which the plurality of antenna elements are mounted, a second surface of the substrate that is on an opposite side of the first surface, and a region between the first surface and the second surface of the substrate.

7. A communication apparatus comprising a communication module,
the communication module comprising:
a plurality of antenna elements, each of which has a transmitting/receiving surface that transmits and receives radio signals; and
an isolation member that is provided between the plurality of antenna elements and has a ground potential to suppress electrical interference between the transmitting/receiving surfaces of the respective antenna elements.

8. The communication apparatus according to claim 7, wherein frequency bands of the radio signals transmitted and received by the plurality of antenna elements are the same.

9. The communication apparatus according to claim 7, further comprising a substrate on which the plurality of antenna elements and the isolation member are mounted,
wherein the plurality of antenna elements and the isolation member are located on the same face of the substrate.

10. The communication apparatus according to claim 8, further comprising a substrate on which the plurality of antenna elements and the isolation member are mounted,
wherein the plurality of antenna elements and the isolation member are located on the same face of the substrate.

11. The communication apparatus according to claim 7, further comprising a substrate on which the plurality of antenna elements and the isolation member are mounted,
wherein the isolation member is located in at least one location selected from a first surface of the substrate on which the plurality of antenna elements are mounted, a second surface of the substrate that is on an opposite side of the first surface, and a region between the first surface and the second surface of the substrate.

12. The communication apparatus according to claim 8, further comprising a substrate on which the plurality of antenna elements and the isolation member are mounted,
wherein the isolation member is located in at least one location selected from a first surface of the substrate on which the plurality of antenna elements are mounted, a second surface of the substrate that is on an opposite side of the first surface, and a region between the first surface and the second surface of the substrate.
